(19) United States
(12) Patent Application Publication
(10) Pub. No.: US 2009/0271522 A1
(43) Pub. Date: Oct. 29, 2009

(54) System, Method and Apparatus For On-Demand Recording Of A Communication Session

(75) Inventors: Shekhar Gupta, Overland Park, KS (US); Rich Schermerhorn, Overland Park, KS (US); Victoria M. Toner, Sheboygan, WI (US); Johnny Hawkins, Kansas City, MO (US); Mike A. Roberts, Overland Park, KS (US)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(73) Assignee: EMBARQ HOLDINGS COMPANY, LLC

(21) Appl. No.: 12/111,531

(22) Filed: Apr. 29, 2008

(51) Int. Cl. G06F 15/16

(52) U.S. Cl. 709/228

(57) ABSTRACT

A method for on-demand recording of a communication session according to one embodiment includes establishing a communication session between a first communication device and a second communication device. The method further includes receiving a request to initiate recording of the communication session at a network server in response to a user input. The method still further includes recording the communication session by the network server in response to receiving the recording request, and storing the recorded communication session in a storage device associated with the network server.

### BACKGROUND OF THE INVENTION

Often a user may wish to record an established communication session, but is unable to do so because the user does not have a recording device, such as a phone recorder or a voice recorder, capable of recording the communication session. For example, the user may wish to record a telephone conversation that he is having with a credit card representative so that he can maintain a record of the conversation. Many existing devices capable of recording telephone conversations are cumbersome to use, often requiring the changing of storage tapes during the telephone conversation. In addition, some systems that have the capability of recording telephone conversations require a user to set up recording of the telephone conversation prior to its establishment, and do not allow a user to begin recording of the telephone conversation after it has been established.

### SUMMARY OF THE INVENTION

Embodiments of the invention allow for on-demand recording of an established communication session between a first communication device and a second communication device. In various embodiments, the second communication device is provided with a user interface configured to allow a user of the second communication device to initiate recording of the established communication session at any time during the communication session.

A method for on-demand recording of a communication session according to one embodiment includes establishing a communication session between a first communication device and a second communication device. The method further includes receiving a request to initiate recording of the communication session at a network server in response to a user input. The method still further includes recording the communication session by the network server in response to receiving the recording request, and storing the recorded communication session in a storage device associated with the network server. In various embodiments, the method further includes sending a request to retrieve the stored communication session to the network server, and sending the stored communication session by the network server in response to receiving the retrieval request.

An apparatus for on-demand recording of a communication session according to one embodiment includes a user interface and a processor(s). The processor(s) is configured to establish a communication session with a communication device. The processor is further configured to send a request to initiate recording of the communication session to a network server in response to a user input via the user interface. In response to receiving the request, the network server is configured to record the communication session and store the recorded communication session in a storage device associated with the network server. In some embodiments, the processor(s) is further configured to send a request to retrieve the stored communication session to the network server, and receive the stored communication session from the network server. In still other embodiments, the processor is further configured to play back the stored communication session.

An apparatus for on-demand recording of a communication session includes a user interface, and a processor(s). The processor(s) is configured to establish a communication session with a communication device. The processor(s) is further configured to initiate recording of the communication session in response to a user input via the user interface. The processor(s) is further configured to record the communication session, and store the recorded communication session in a storage device associated with the apparatus. In various embodiments, the storage device is removably coupled to the apparatus. In some embodiments, the processor(s) is further configured to play back the stored communication session from the storage device.

### BRIEF DESCRIPTION OF THE DRAWINGS

Illustrative embodiments of the present invention are described in detail below with reference to the attached drawing figures, which are incorporated by reference herein and wherein:

FIG. 1 illustrates an embodiment of a system for on-demand recording of a communication session;

FIG. 2 illustrates an embodiment of a procedure for on-demand recording of a communication session;

FIG. 3 illustrates another embodiment of a system for on-demand recording of a communication session; and

FIG. 4 illustrates another embodiment of a procedure for on-demand recording of a communication session.

### DETAILED DESCRIPTION OF THE INVENTION

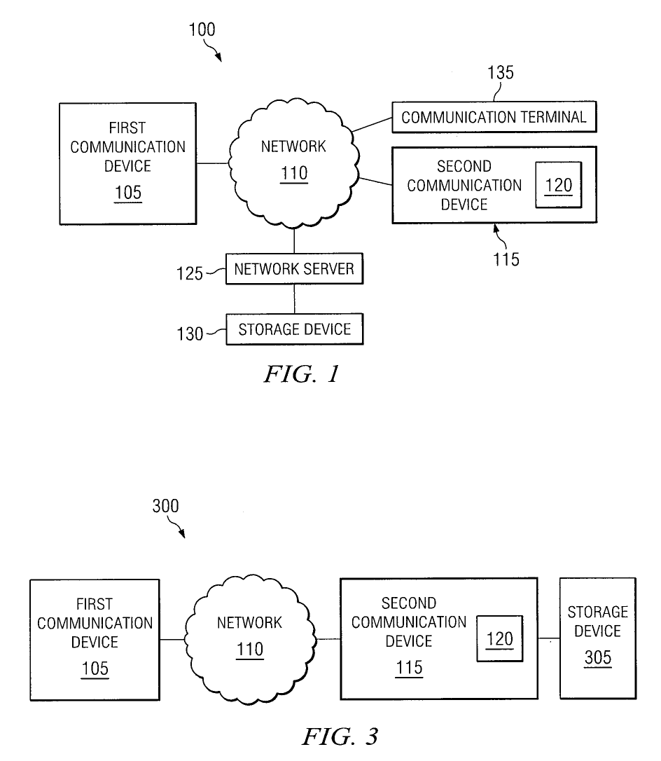

FIG. 1 illustrates a system for on-demand recording of a communication session. The system 100 includes a first communication device 105 coupled to a network 110. In at least one embodiment of the invention, the first communication device 105 is a telephone handset. In at least one embodiment, the network 110 is a digital multiplex system (DMS), a Signaling System 7 (SS7) or a Voice over Internet Protocol (VoIP) network. The network 110 may further be in communication with a second communication device 115. In at least one embodiment of the invention, the second communication device 115 is a telephone handset. The second communication device 115 includes a user interface 120. The user interface 120 is configured to allow a user or operator of the second communication device 115 to provide input to the second communication device 115. In at least one embodiment, the user interface 120 is a programmable soft-key. In still other embodiments, the user interface 120 is a hard-key attached to the second communication device 115. The system 100 further includes a network server 125 in communication with the network 110. A storage device 130 may be in communication with the network server 125. The storage device 130 may include a disk drive, dynamic memory, or any other memory device as understood in the art. The network server 125 may be configured to record one or more communication sessions between the first communication device 105 and the second communication device 115, and store the recorded communication session(s) on the storage device 130. In at least one embodiment, each user of the communication device 115 may be allocated a predetermined amount of space 130 by the network server 125 for recording communication sessions on the storage device 130. In various embodiments, on-demand recording of communication sessions may be offered by a service provider, and a user may subscribe to the on-demand recording service through the service provider. For example, in one embodiment the user may pay a monthly fee to the service provider for the on-demand recording service. In still other embodiments, the user may pay a fee for each communication session recorded, or on a per-minute basis for the duration of the communication session. In still other embodiments, the network server 125 may be located at a customer premises.

The system 100 further includes a communication terminal 135 in communication with the network 110. The communication terminal 135 may be configured to allow a user of the communication terminal 135 to access the network server 125 and retrieve a stored communication session from the storage device 130. In still other embodiments, the user interface 120 may include a web page accessed via the communication terminal 135 allowing a user to initiate recording of the established communication session. In at least one embodiment, the communication terminal 135 is configured to play back the retrieved communication session to a user of the communication terminal 135. In still other embodiments, the communication terminal 135 is configured to store the retrieved communication session on a storage media, such as a hard disc, a compact disc, a DVD disc, or removable flash media.

In one embodiment, a communication session may be established between the first communication device 105 and the second communication device 115 via the network 110. In some embodiments, the network 110 includes one or more switches configured to create a connection between the first communication device 105 and the second communication device 115. In at least one embodiment, the communication session is a voice call. During the communication session, a user of the second communication device 115 may initiate the sending of a recording request to the network server 125 using the user interface 120. In at least one embodiment, the user interface 120 includes a soft-key and the user of the second communication device 115 presses the soft-key to initiate the request.

In response to receiving the request, network server 125 may receive the communication session between the first communication device 105 and the second communication device 115 via the network 110 and begin recording the communication session between the first communication device 105 and the second communication device 115. In at least one embodiment, the network server 125 is linked to a call routing switch, located within the network 110, coupling the first communication device 105 and the second communication device 115. In such an embodiment, the call routing switch receives the request from the second communication device 115 and, responsive to the request, establishes a virtual path to the network server 125 and routes the communication session between the first communication device 105 and the second communication device 115 from the call routing switch through the network server 125. As the communication session is routed through the network server 125, the network server records the communication session. Embodiments of the invention allow for on-demand recording of an established communication session by providing for the capability of a user to initiate recording of the communication session via a user interface associated with a communication device.

During recording of the communication session between the first communication device 105 and the second communication device 115, the communication session is stored on the storage device 130 by the network server 125. In response to a user input from the user interface 120 or by a disconnection of the communication session between the first communication device 105 and the second communication device 115, the network server 125 stops recording the communication session.

The communication session may be stored in the storage device 130 in a variety of formats, including an mp3 file, a wave file or any other audio format. At a later time, a user of the second communication device 115 can retrieve the stored communication session from the storage device 130. In at least one embodiment, the user of the second communication device 115 may request retrieval of the stored session from the storage device 130 using the user interface 120. The stored communication session is then retrieved from the storage device 130 by the second communication device and then played back to the user via the second communication device 115. In still other embodiments, a user may use communication terminal 135 to retrieve and play back the stored communication session from the storage device 130. In still other embodiments, the stored communication session 130 may be retrieved by a user of the communication terminal 135 and stored on a removable media, such as a compact disk, a flash drive or a portable audio player coupled to the communication terminal 135.

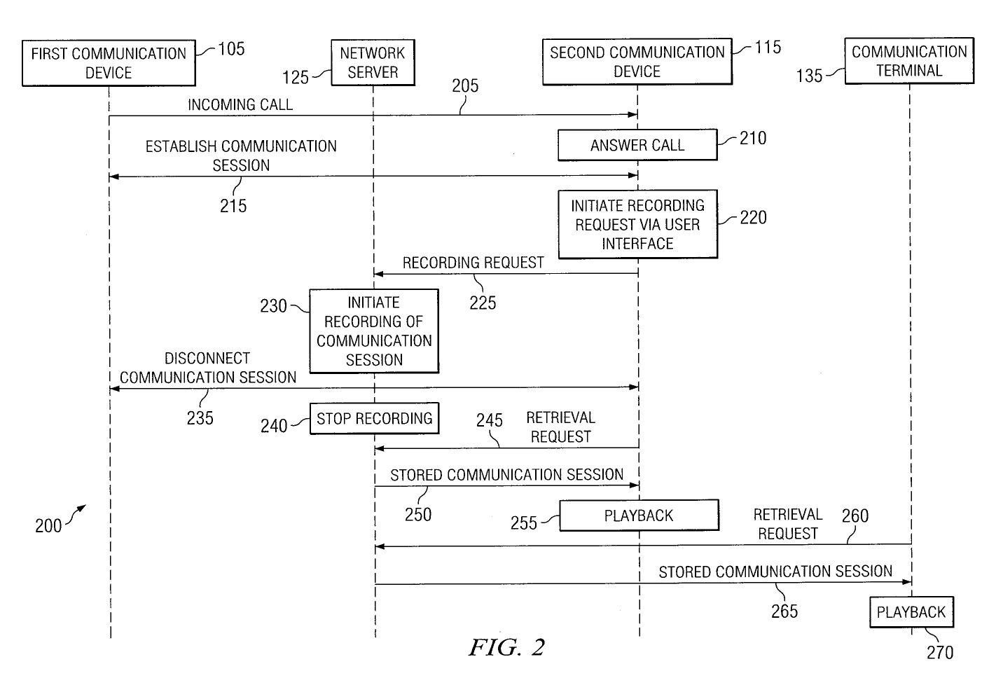

FIG. 2 is an embodiment of a procedure 200 for on-demand recording of a communication session. In step 205, an incoming call from the first communication device 105 is received by the second communication device 115. In step 210, the second communication device 115 answers the incoming call. In step 215, a communication session is established between the first communication device 105 and the second communication device 115. In step 220, the user of the second communication device 115 pushes the user interface 120 to initiate recording of the communication session. For example, in particular embodiments, a user of the second communication device 115 clicks a hard-key or a soft-key on the second communication device 115 to initiate recording of the communication session. In a particular embodiment, the user may press a particular key sequence, for example, a “**”, a “##”, or “*99” on a keypad of the communication device 115 to initiate recording of the communications session. In still other embodiments, interactive voice response (IVR) may be used to detect an audible request, such as a spoken command, from the user of the second communication device 115 to initiate recording of the communication session. In step 225, a recording request is sent from second communication device 115 to the network server 125 in response to the pushing of the user interface 120. In a particular embodiment, the recording request may be made from a user of the second communication device 115 using a dual tone multiple frequency (DTMF) signal that is received by the network server 125 and blocked or filtered from passing to the first communication device 105 to initiate recording of the communication session.

The network server 125 initiates recording of the communication session between the first communication device 105 and the second communication device 115 in response to receiving the recording request. During the duration of the communication session, the network server 125 continues the recording of the communication session and storage of the communication session in the storage device 130. In step 235, the communication session between the first communication device 105 and the second communication device 115 is disconnected. In response to the disconnection of the communication session, the network server 125 stops recording the communication session in step 240. In alternate embodiment, the user of the second communication device 115 may stop the recording of the communication session at any time during the call by pushing the user interface 120.

In step 245, the second communication device 115 sends a request for retrieval of the stored communication session to the network server 125. In step 250, the network server 125 sends the stored communication session to the second communication device 115. In step 255, the second communication device 115 begins playback of the stored communication session to the user. In step 260, a user of communication terminal 135 sends a request for retrieval of the recorded communication session to the network server 125. In at least one embodiment, the user of the communication terminal 135 sends the request for retrieval via a web page interface. In step 265, the network server 125 sends the recorded communication session to the communication terminal 135. In step 270, a user of the communication terminal 135 plays back the recorded communication session. In still other embodiments, communication terminal 135 is configured to allow a user to store the recorded communication session on a storage device such as a hard drive or a removable storage medium.

In some embodiments, the system 100 is configured to recognize when a call is placed to or received from a particular party and automatically record the communication session. For example, in one embodiment the system 100 may be configured to recognize the telephone number associated with a particular calling party or called party. In a particular embodiment, a particular party for which automatic recording should be enabled is configured using a web portal. In still other embodiments, the particular party for which automatic recording is to be enabled is configured using a communication device such as the second communication device 115. In still other embodiments, a particular party may be enabled for automatic recording based on past call history. In at least one embodiment, the network server 125 begins recording when a communication session is established with the particular party for which automatic recording has been enabled. In a particular embodiment, an audible prompt, such as a voice prompt or audible tone, is presented to the user of the second communication device 115 indicating that the communication session is going to be automatically recorded. In such an embodiment, the user of the second communication device 115 is presented with an option of stopping the automatic recording of the communication session. In one embodiment, the user of the second communication device 115 may stop recording of the communication session using the user interface 120. In still other embodiments, the system 100 is configured to prompt the user of the second communication device 115 to determine if the communication session is to be recorded, and begins recording of the communication session if the user answers in the affirmative. In a particular embodiment, the system 100 is configured to determine the parties for which a prompt is presented to the user of the second communication device to determine if the communication session is to be recorded based upon past call history of the parties.

FIG. 3 illustrates another embodiment of a system for on-demand recording of a communication session. The system 300 is similar to the system 100 of FIG. 1 does not include network server 125, storage device 130, or communication terminal 135. The system 300 further includes a storage device 310 coupled to the second communication device 115. Upon receiving an input from a user via the user interface 120, the second communication device 115 is configured to record one or more communication sessions established between the first communication device 105 and the second communication device 115 and store the recorded communication session(s) on the storage device 305. In at least one embodiment, the storage device 305 is a hard disc, a compact disc, a DVD disc, or removable flash media. In various embodiments, the storage device 305 is a removable and/or external storage device coupled to the second communication device 115. In at least one embodiment, the storage device 305 is removably coupled to the second communication device 115. In a particular embodiment, the storage device 305 is coupled to the second communication device 115 via a Universal Serial Bus (USB) connection. In still other embodiments, the storage device 305 is located internally to the second communication device 115. The second communication device 115 is configured to allow the user of the second communication device 115 to retrieve a stored communication session from the storage device 305 and play back the retrieved communication session to the user of the second communication device 115.

In one embodiment, a communication session is established between the first communication device 105 and the second communication device 115 via the network 110. In some embodiments, the network 110 includes one or more switches configured to couple the first communication device 105 and the second communication device 115. In at least one embodiment, the communication session is a voice call. During the communication session, a user of the second communication device 115 initiates recording of the communication session via user input using the user interface 120. In at least one embodiment, the user interface 120 includes a soft-key and the user of the second communication device 115 presses the soft-key to initiate the recording of the communication session.

In response to receiving the user input, the second communication device 115 records the communication session between the first communication device 105 and the second communication device 115, and stores the recorded communication session on the storage device 305. In response to a user input from the user interface 120 or by a disconnection of the communication session between the first communication device 105 and the second communication device 115, the second communication device 115 stops recording the communication session.

The communication session may be stored in the storage device 130 in a variety of formats, including an mp3, a wave file or any other audio format. At a later time, a user of the second communication device 115 can retrieve the stored communication session from the storage device 130. In at least one embodiment, the user of the second communication device 115 requests retrieval of the stored session from the storage device 130 using the user interface 120. The stored communication session is then retrieved from the storage device 305 by the second communication device and then played back to the user via the second communication device 115. In still other embodiments, the storage device 305 may be uncoupled from the second communication device 115 and coupled to a communication terminal, such as a computer, to allow access to the stored communication session by a user. In still other embodiments, the second communication device 115 can be coupled to a computer or a media player and the stored communication session can be transferred to the computer or media player and played back by the computer or media player.

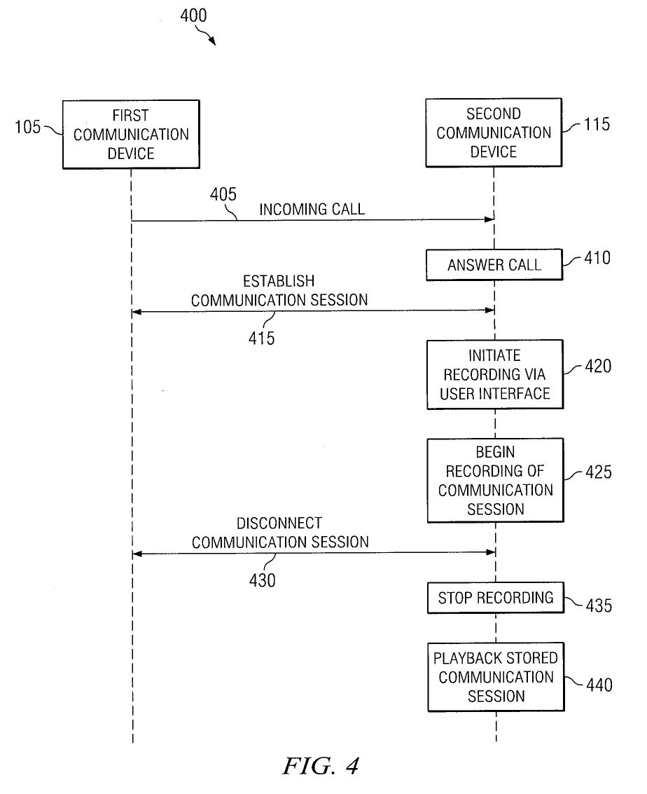

FIG. 4 is another embodiment of a procedure 400 for on-demand recording of a communication session. In step 405, an incoming call from the first communication device 105 is received by the second communication device 115. In step 410, the second communication device 115 answers the incoming call. In step 415, a communication session is established between the first communication device 105 and the second communication device 115. In step 420, the user of the second communication device 115 initiates recording of the communication session via the user interface 120. In step 425, the second communication device 115 begins recording communication session between the first communication device 105 and the second communication device 115 in response to the user input. During the duration of the communication session, the second communication device 115 continues the recording of the communication session and storage of the communication session in the storage device 305.

In step 430, the communication session between the first communication device 105 and the second communication device 115 is disconnected. In response to the disconnection of the communication session, the second communication device 115 stops recording the communication session in step 435. In alternate embodiment of the invention, the user of the second communication device 115 may stop the recording of the communication session at any time during the call via the user interface 120. At a later time, the second communication device 115 begins playback of the stored communication session to the user in step 440.

The illustrative embodiments can take the form of an entirely hardware embodiment, an entirely software embodiment or an embodiment containing both hardware and software elements. Furthermore, the illustrative embodiments can take the form of a computer program product accessible from a computer-usable or computer-readable medium providing program code for use by or in connection with a computer or any instruction execution system. For the purposes of this description, a computer-usable or computer-readable medium can be any tangible apparatus that can contain, store, communicate, propagate, or transport the program for use by or in connection with the instruction execution system, apparatus, or device. In various embodiments, the second communication device 115 includes one or more processors operable to execute computer executable instructions to perform the various capabilities of the second communication device 115 described herein. Similarly, the network server 125 includes one or more processors operable to execute computer executable instructions to perform the various capabilities of the network server 125 described herein.

The computer-usable or computer-readable medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

Further, a computer storage medium may contain or store a computer-readable program code such that when the computer-readable program code is executed on a computer, the execution of this computer-readable program code causes the computer to transmit another computer-readable program code over a communication link. This communication link may use a medium that is, for example without limitation, physical or wireless.

The previous detailed description is of a small number of embodiments for implementing the invention and is not intended to be limiting in scope. For example, although particular embodiments have been illustrated by using a voice communication session, it should be understood that the principles of the invention are applicable to other types of communication sessions such as video and audio conferencing. One of skill in this art will immediately envisage the methods and variations used to implement this invention in other areas than those described in detail. The following claims set forth a number of the embodiments of the invention disclosed with greater particularity.

What is claimed as new and desired to be protected by Letters Patent of the United States is:

1. A method for on-demand recording of a communication session comprising:
establishing a communication session between a first communication device and a second communication device;
receiving a request to initiate recording of the communication session at a network server in response to a user input;
recording the communication session by the network server in response to receiving the recording request; and
storing the recorded communication session in a storage device associated with the network server.

2. The method of claim 1 further comprising:
sending a request to retrieve the stored communication session to the network server; and
sending the stored communication session by the network server in response to receiving the retrieval request.

3. The method of claim 1, wherein establishing the communication session is performed before receiving the request to initiate recording.

4. The method of claim 1 further comprising:
sending a request to retrieve the stored communication session to the network server from a communication device; and
sending the stored communication session to the communication device by the network server in response to receiving the retrieval request.

5. The method of claim 1 further comprising:
sending a request to retrieve the stored communication session to the network server from a communication terminal;
sending the stored communication session to the communication terminal by the network server in response to receiving the retrieval request.

6. The method of claim 5, further comprising:
storing, by the communication terminal, the recorded communication session on a removable storage medium.

7. The method of claim 1, wherein the received request is provided by a DTMF signal from one of the communication devices, and further comprising preventing the DTMF signal from passing to the other communication device.

8. The method of claim 1, further comprising:
establishing a virtual path to the network server; and
routing the communication session through the network server.

9. The method of claim 1, further comprising prompting a user of the second communication device to determine if the communication session is to be recorded by the network server.

10. An apparatus for on-demand recording of a communication session comprising:
a user interface; and
at least one processor, the at least one processor configured to:
establish a communication session with a communication device; and
send a request to initiate recording of the communication session to a network server in response to a user input via the user interface;
wherein the network server is configured to record the communication session and store the recorded communication session in a storage device associated with the network server in response to receiving the request.

11. The apparatus of claim 10, wherein the at least one processor is further configured to:
send a request to retrieve the stored communication session to the network server; and
receive the stored communication session from the network server.

12. The apparatus of claim 10, wherein establishing the communication session is performed before sending the request to initiate recording.

13. The apparatus of claim 10, wherein the apparatus comprises a telephone handset.

14. The apparatus of claim 10, wherein the user interface comprises a soft-key.

15. The apparatus of claim 10, wherein the user interface comprises a hard-key.

16. The apparatus of claim 10, wherein the request to initiate recording is provided by a DTMF signal from the apparatus, and wherein the DTMF signal is prevented from passing to the communication device.

17. An apparatus for on-demand recording of a communication session comprising:
a user interface; and
at least one processor, the at least one processor configured to:
establish a communication session with a communication device;
initiate recording of the communication session in response to a user input via the user interface;
record the communication session; and
store the recorded communication session in a storage device associated with the apparatus.

18. The apparatus of claim 17, wherein the storage device is removably coupled to the apparatus.

19. The apparatus of claim 17, wherein the at least one processor is further configured to:
play back the stored communication session from the storage device.

20. The apparatus of claim 17, wherein the apparatus comprises a telephone handset.
